(19) United States
(12) Patent Application Publication
(10) Pub. No.: US 2014/0006681 A1
(43) Pub. Date: Jan. 2, 2014

(54) MEMORY MANAGEMENT IN A VIRTUALIZATION ENVIRONMENT

(71) Applicants: Wei-Hsiang CHEN, Sunnyvale, CA (US); Ricardo RAMIREZ, Sunnyvale, CA (US); Hai N. NGUYEN, Redwood City, CA (US)

(72) Inventors: Wei-Hsiang CHEN, Sunnyvale, CA (US); Ricardo RAMIREZ, Sunnyvale, CA (US); Hai N. NGUYEN, Redwood City, CA (US)

(73) Assignee: Broadcom Corporation, Irvine, CA (US)

(21) Appl. No.: 13/538,217

(22) Filed: Jun. 29, 2012

(51) Int. Cl. G06F 12/08

(52) U.S. Cl. 711/3; 711/E12.017

(57) ABSTRACT

An architecture is described for performing memory management in a virtualization environment. Multiple levels of caches are provided to perform address translations, where at least one of the caches contains a mapping between a guest virtual address and a host physical address. This type of caching implementation serves to minimize the need to perform costly multi-stage translations in a virtualization environment.

### BACKGROUND OF THE INVENTION

1. Field

This disclosure concerns architectures and methods for implementing memory management in a virtualization environment.

2. Background

A computing system utilizes memory to hold data that the computing system uses to perform its processing, such as instruction data or computation data. The memory is usually implemented with semiconductor devices organized into memory cells, which are associated with and accessed using a memory address. The memory device itself is often referred to as “physical memory” and addresses within the physical memory are referred to as “physical addresses” or “physical memory addresses”.

Many computing systems also use the concept of “virtual memory”, which is memory that is logically allocated to an application on a computing system. The virtual memory corresponds to a “virtual address” or “logical address” which maps to a physical address within the physical memory. This allows the computing system to de-couple the physical memory from the memory that an application thinks it is accessing. The virtual memory is usually allocated at the software level, e.g., by an operating system (OS) that takes responsibility for determining the specific physical address within the physical memory that correlates to the virtual address of the virtual memory. A memory management unit (MMU) is the component that is implemented within a processor, processor core, or central processing unit (CPU) to handle accesses to the memory. One of the primary functions of many MMUs is to perform translations of virtual addresses to physical addresses.

Modern computing systems may also implement memory usage in the context of virtualization environments. A virtualization environment contains one or more “virtual machines” or a “VMs”, which are software-based implementation of a machine in a virtualization environment in which the hardware resources of a real “host” computer (or “root” computer where these terms are used interchangeably herein) are virtualized or transformed into the underlying support for the fully functional “guest” virtual machine that can run its own operating system and applications on the underlying physical resources just like a real computer. By encapsulating an entire machine, including CPU, memory, operating system, storage devices, and network devices, a virtual machine is completely compatible with most standard operating systems, applications, and device drivers. Virtualization allows one to run multiple virtual machines on a single physical machine, with each virtual machine sharing the resources of that one physical computer across multiple environments. Different virtual machines can run different operating systems and multiple applications on the same physical computer.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine is not utilized to perform useful work. This is wasteful and inefficient if there are users on other physical machines which are currently waiting for computing resources. To address this problem, virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

Memory is one type of a physical resource that can be managed and utilized in a virtualization environment. A virtual machine that implements a guest operating system may allocate its own virtual memory (“guest virtual memory”) which corresponds to a virtual address (“guest virtual address” or “GVA”) allocated by the guest operating system. Since the guest virtual memory is being allocated in the context of a virtual machine, the OS will relate the GVA to what it believes to be an actual physical address, but which is in fact just virtualized physical memory on the virtualized hardware of the virtual machine. This virtual physical address is often referred to as a “guest physical address” or “GPA”. The guest physical address can then be mapped to the underlying physical memory within the host system, such that a guest physical address maps to host physical address.

As is evident from the previous paragraph, each memory access in a virtualization environment may therefore correspond to at least two levels of indirection. A first level of indirection exists between the guest virtual address and the guest physical address. A second level of indirection exists between the guest physical address and the host physical address.

Conventionally, multiple translation procedures are separately performed to implement each of these two levels of indirection for the memory access in a virtualization environment. Therefore, a MMU in a virtualization environment would perform a first translation procedure to translate the guest virtual address into the guest physical address. The MMU would then perform a second translation procedure to translate the guest physical address into the host physical address.

The issue with this multi-stage translation approach is that each translation procedure is typically expensive to perform, e.g., in terms of time costs, computation costs, and memory access costs.

Therefore, there is a need for an improved approach to implement memory management which can more efficiently perform memory access in a virtualization environment.

### BRIEF SUMMARY OF THE INVENTION

The following presents a simplified summary of some embodiments in order to provide a basic understanding of the invention. This summary is not an extensive overview and is not intended to identify key/critical elements or to delineate the scope of the claims. Its sole purpose is to present some embodiments in a simplified form as a prelude to the more detailed description that is presented below.

The present disclosure describes an architecture and method for performing memory management in a virtualization environment. According to some embodiments, multiple levels of virtualization-specific caches are provided to perform address translations, where at least one of the virtualization-specific caches contains a mapping between a guest virtual address and a host physical address. This type of caching implementation serves to minimize the need to perform costly multi-stage translations in a virtualization environment. In some embodiments, a micro translation lookaside buffer (uTLB) is used to provide a mapping between a guest virtual address and a host physical address. For address mapping that are cached in the uTLB, this approach avoids multiple address translations to obtain a host physical address from a guest virtual address.

Also described is an approach to implement a lookup structure that includes a content addressable memory (CAM) which is associated with multiple memory components. The CAM provides one or more pointers into the plurality of downstream memory structures. In some embodiments, a TLB for caching address translation mappings is embodied as a combination of a CAM associated with parallel downstream memory structures, where a first memory structure corresponds to a host address mappings and the second memory structure corresponds to guest address mappings.

Further details of aspects, objects, and advantages of various embodiments are described below in the detailed description, drawings, and claims. Both the foregoing general description and the following detailed description are exemplary and explanatory, and are not intended to be limiting as to the scope of the disclosure.

### BRIEF DESCRIPTION OF THE DRAWINGS/FIGURES

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 illustrates an example approach for performing address translations.

FIG. 2 illustrates a system for performing address translations according to some embodiments.

FIG. 3 illustrates a multi-level cache implementation of a memory management mechanism for performing address translations according to some embodiments.

FIG. 4 shows a flowchart of an approach for performing address translations according to some embodiments.

FIGS. 5A-G provide an illustrative example of an address translation procedure according to some embodiments.

FIGS. 6A-B illustrate a memory management mechanism having a CAM associated with multiple memory devices according to some embodiments.

FIGS. 7A-C illustrate example structures that can be used to implement memory management mechanism having a CAM associated with multiple memory devices according to some embodiments.

FIG. 8 shows a flowchart of an approach for performing address translations according to some embodiments.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF THE INVENTION

This disclosure describes improved approaches to perform memory management in a virtualization environment. According to some embodiments, multiple levels of caches are provided to perform address translations, where at least one of the caches contains a mapping between a guest virtual address and a host physical address. This type of caching implementation serves to minimize the need to perform costly multi-stage translations in a virtualization environment.

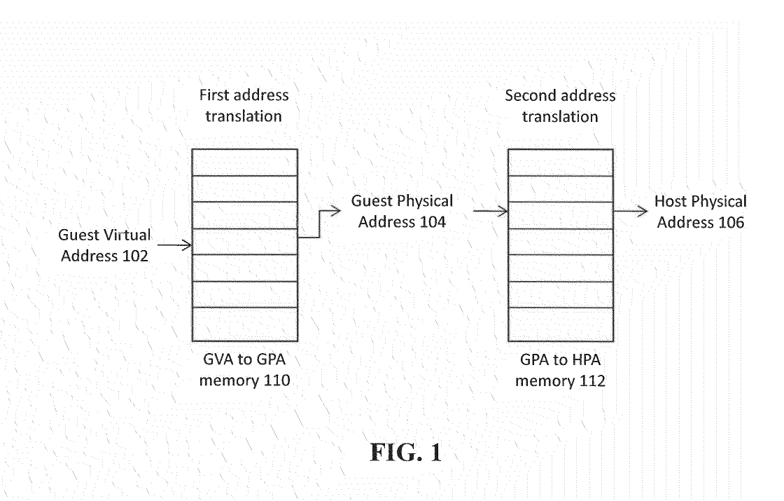

FIG. 1 illustrates the problem being addressed by this disclosure, where each memory access in a virtualization environment normally corresponds to at least two levels of address indirections. A first level of indirection exists between the guest virtual address 102 and the guest physical address 104. A second level of indirection exists between the guest physical address 104 and the host physical address 106.

A virtual machine that implements a guest operating system will attempt to access guest virtual memory using the guest virtual address 102. One or more memory structures 110 may be employed to maintain information that relates the guest virtual address 102 to the guest physical address 104. Therefore, a first translation procedure is performed to access the GVA to GPA memory structure(s) 110 to translate the guest virtual address 102 to the guest physical address 104.

Once the guest physical address 104 has been obtained, a second translation procedure is performed to translate the guest physical address 104 into the host physical address 106. Another set of one or more memory structures 112 may be employed to maintain information that relates the guest physical address 104 to the host physical address 106. The second translation procedure is performed to access the GPA to HPA memory structure(s) 112 to translate the guest physical address 104 to the host physical address 106.

As previously noted, the issue with this multi-stage translation approach is that each translation procedure may be relatively expensive to perform. If the translation data is not cached, then one or more page tables would need to be loaded and processed to handle each address translation for each of the two translation stages. Even if the translation data is cached in TLBs, multiple TLB accesses are needed to handle the two stages of the address translation, since a first TLB is accessed for the GVA to GPA translation and a second TLB is accessed for the GPA to HPA translation.

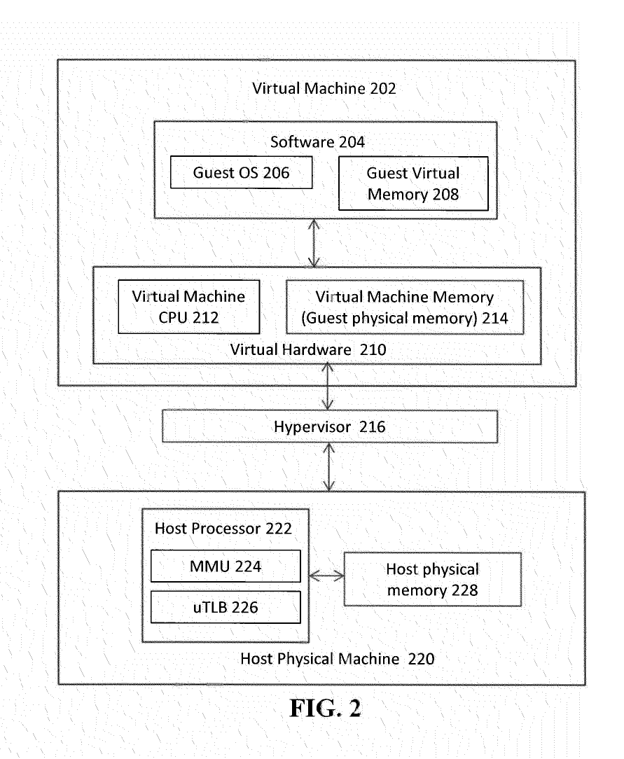

FIG. 2 illustrates an improved system for implementing memory management for virtualization environments according to some embodiments. The software application that ultimately desires the memory access resides on a virtual machine 202, which corresponds to a software-based implementation of a machine in a virtualization environment in which the resources of the real host physical machine 220 are provided as the underlying hardware support for the fully functional virtual machine 202. The virtual machine 202 implements a virtual hardware system 210 that includes a virtualized processor 212 and virtualized machine memory 214. The virtualized machine memory 214 corresponds to guest physical memory 214 having a set of guest physical addresses. The virtual machine 202 can run its own software 204, which includes a guest operating system 206 (and software application running on the guest OS 206) that accesses guest virtual memory 208. The guest virtual memory 208 corresponds to a set of guest virtual addresses.

Virtualization works by inserting a thin layer of software on the computer hardware or on a host operating system, which contains a virtual machine monitor or “hypervisor” 216. The hypervisor 216 transparently allocates and manages the underlying resources within the host physical machine 220 on behalf of the virtual machine 202. In this way, applications on the virtual machine 202 are completely insulated from the underlying real resources in the host physical machine 220. Virtualization allows multiple virtual machines 202 to run on a single host physical machine 220, with each virtual machine 202 sharing the resources of that host physical machine 220. The different virtual machines 202 can run different operating systems and multiple applications on the same host physical machine 220. This means that multiple applications on multiple virtual machines 202 may be concurrently running and sharing the same underlying set of memory within the host physical memory 228.

In the system of FIG. 2, multiple levels of caching are provided to perform address translations, where at least one of the caching levels contains a mapping between a guest virtual address and a host physical address. This type of caching implementation serves to minimize the need to perform costly multi-stage translations in a virtualization environment.

Within the host processor 222 of host machine 220, the multiple levels of caching is implemented with a first level of caching provided by a micro-TLB 226 (“uTLB”) and a second level of caching provided by a memory management unit (“MMU”) 224. The first level of caching provided by the uTLB 226 provides a direct mapping between a guest virtual address and a host physical address. If the necessary mapping is not found in the uTLB 226 (or the mapping exists in uTLB 226 but is invalid), then a second level of caching provided by the MMU 224 can be used to perform multi-stage translations of the address data.

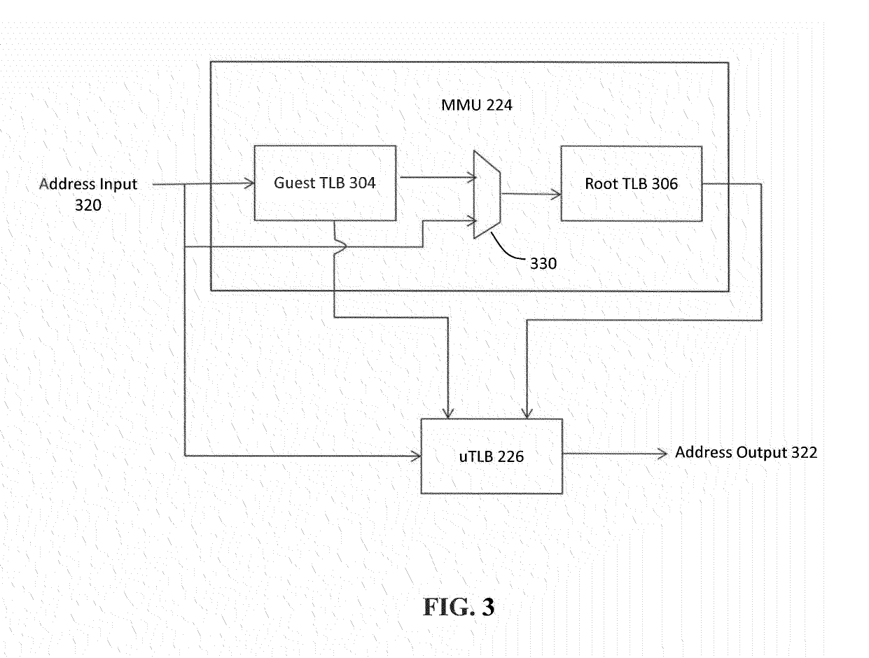

FIG. 3 provides a more detailed illustration of the multiple levels of virtualization-specific caches to perform address translations that are provided by the combination of the MMU 224 and the uTLB 226.

The MMU 224 includes multiple lookup structures to handle the multiple address translations that can be performed to obtain a host physical address (address output 322) from an address input 320. In particular, the MMU 224 includes a guest TLB 304 to provide a translation of an address input 320 in the form of a guest virtual address to a guest physical address. The MMU also includes a root TLB 306 to provide address translations to host physical addresses. In the virtualization context, the input to the root TLB 306 is a guest physical address that is mapped within the root TLB 306 to a host physical address. In the non-virtualization context, the address input 320 is an ordinary virtual address that bypasses the guest TLB 304 (via mux 330), and which is mapped within the root TLB 306 to its corresponding host physical address.

In general, a TLB is used to reduce virtual address translation time, and is often implemented as a table in a processor's memory that contains information about the pages in memory that have been recently accessed. Therefore, the TLB functions as a cache to enable faster computing because it caches a mapping between a first address and a second address. In the virtualization context, the guest TLB 304 caches mappings between guest virtual addresses and guest physical addresses, while the root TLB 306 caches mappings between guest physical addresses and host physical addresses.

If a given memory access request from an application does not correspond to mappings cached within the guest TLB 304 and/or root TLB 306, then this cache miss/exception will require much more expensive operations by a page walker to access page table entries within one or more page tables to perform address translations. However, once the page walker has performed the address translation, the translation data can be stored within the guest TLB 304 and/or the root TLB 306 to cache the address translation mappings for a subsequent memory access for the same address values.

While the cached data within combination of the guest TLB 304 and the root TLB 306 in the MMU 224 provides a certain level of performance improvement, at least two lookup operations (a first lookup in the guest TLB 304 and a second lookup in the root TLB 306) are still required with these structures to perform a full translation from a guest virtual address to a host physical address.

To provide even further processing efficiencies, the uTLB 226 provides a single caching mechanism that cross-references a guest virtual address with its corresponding absolute host physical addresses in the physical memory 228. The uTLB 226 enables faster computing because it allows translations between the guest virtual address to the host physical address translations to be performed with only a single lookup operation within the uTLB 226.

In effect, the uTLB 226 provides a very fast L1 cache for address translations between guest virtual addresses and host physical addresses. The combination of the guest TLB 304 and the root TLB 306 in the MMU 224 therefore provides a (less efficient) L2 cache that can nevertheless still be used to provide the desired address translation if the required mapping data is not in the L1 cache (uTLB 226). If the desired mapping data is not in either the L1 and L2 caches, then the less efficient page walker is employed to obtain the desired translation data, which is then used to populate either or both the L1 (uTLB 226) and L2 caches (guest TLB 304 and root TLB 306).

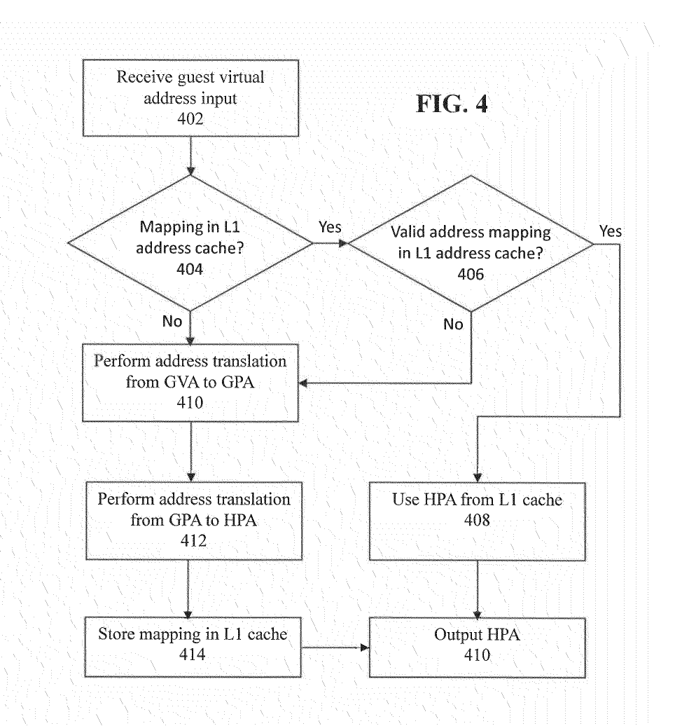

FIG. 4 shows a flowchart of an approach to implement memory accesses using the multi-level caching structure of the present embodiment in a virtualization environment. At 402, the guest virtual address is received for translation. This occurs, for example, when software on a virtual machine needs to perform some type of memory access operation. For example, an operating system on a virtual machine may have a need to access a memory location that is associated with a guest virtual address.

At 404, a check is made whether a mapping exists for that guest virtual address within the L1 cache. The uTLB in the L1 cache includes one or more memory structures to maintain address translation mappings for guest virtual addresses, such as table structures in a memory device to map between different addresses. A lookup is performed within the uTLB to determine whether the desired mapping is currently cached within the uTLB.

Even if a mapping does exist within the uTLB for the guest virtual address, under certain circumstances it is possible that the existing mapping within the uTLB is invalid and should not be used tor the address translation. For example, as described in more detail below, since the address transactions were last cached in the uTLB the memory region of interest may have changed from being mapped memory to unmapped memory. This change in status of the cached translation data for the memory region would render the previously cached data in the uTLB invalid.

Therefore, at 406, cached data for guest virtual addresses within the uTLB are checked to determine whether they are still valid. If the cached translation data is still valid, then at 408, the data within the L1 cache of the uTLB is used to perform the address translation from the guest virtual address to the host physical address. Thereafter, at 410, the host physical address is provided to perform the desired memory access.

If the guest virtual address mapping is not found in the L1 uTLB cache, or is found in the uTLB but the mapping is no longer valid, then the L2 cache is checked for the appropriate address translations. At 410, a lookup is performed within a guest TLB to perform a translation from the guest virtual address to a guest physical address. If the desired mapping data is not found in the guest TLB, then a page walker (e.g., a hardware page walker) is employed to perform the translation and to then store the mapping data in the guest TLB.

Once the guest physical address is identified, another lookup is performed at 412 within a root TLB to perform a translation from the guest physical address to a host physical address. If the desired mapping data is not found in the root TLB, then a page walker is employed to perform the translation between the GPA and the HPA, and to then store the mapping data in the root TLB.

At 414, the mapping data from the L2 cache (guest TLB and root TLB) is stored into the L1 cache (uTLB). This is to store the mapping data within the L1 cache so that the next time software on the virtual machine needs to access memory at the same guest virtual address, only a single lookup is needed (within the uTLB) to perform the necessary address translation for the memory access. Thereafter, at 410, the host physical address is provided for memory access.

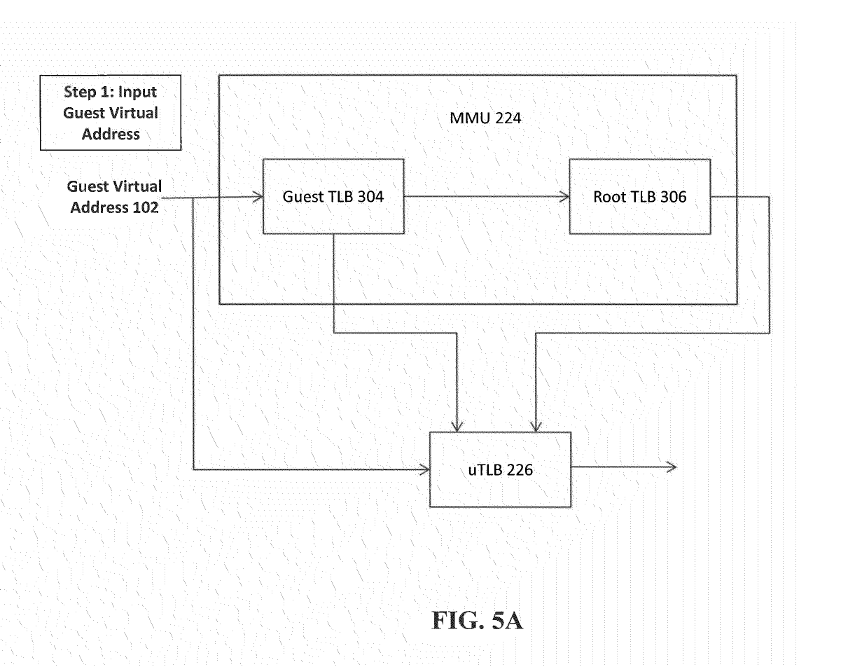

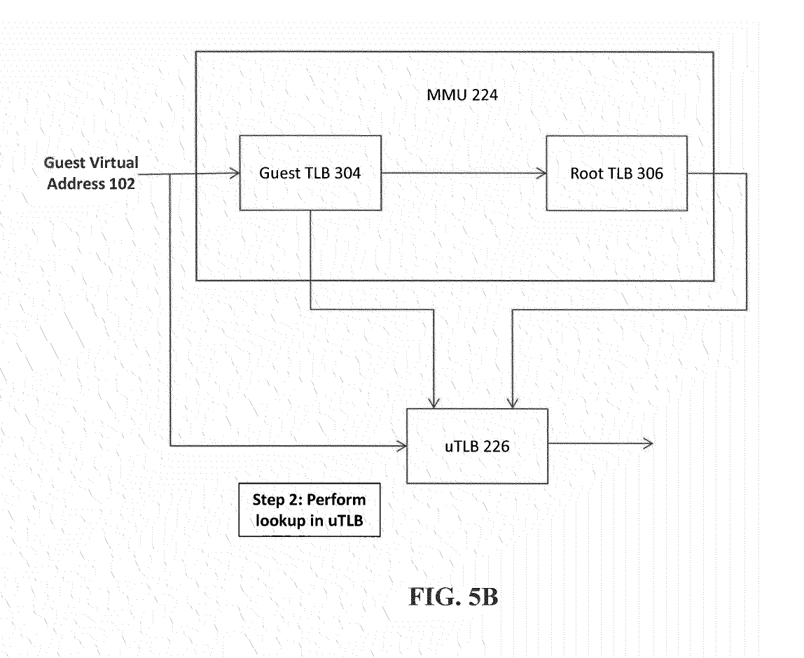

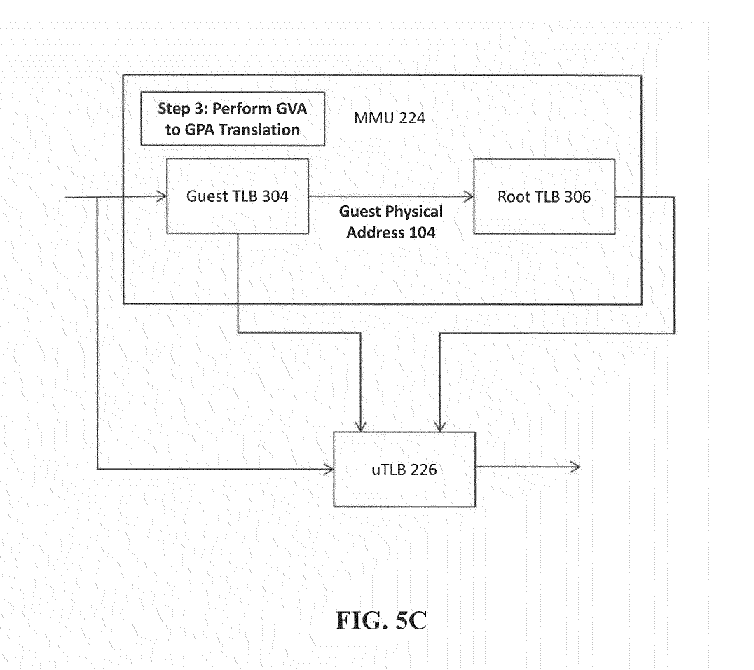

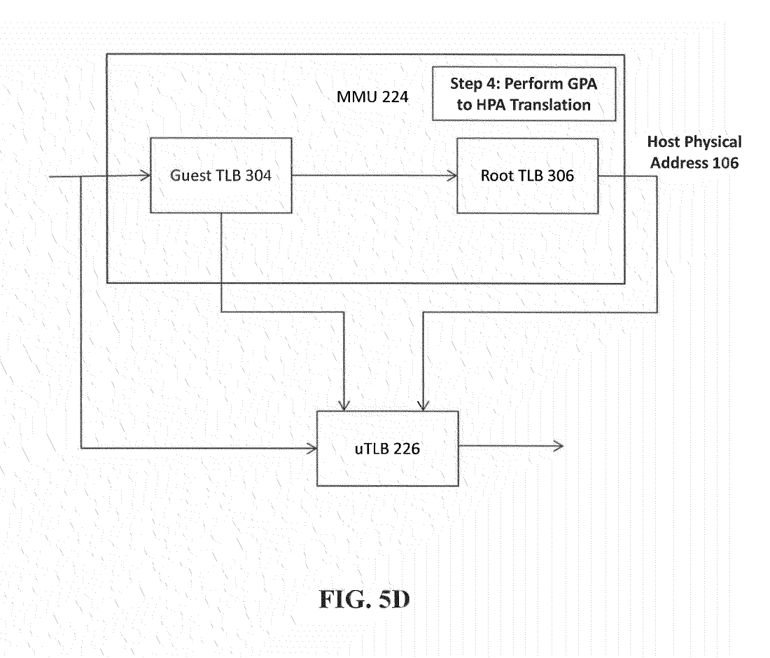

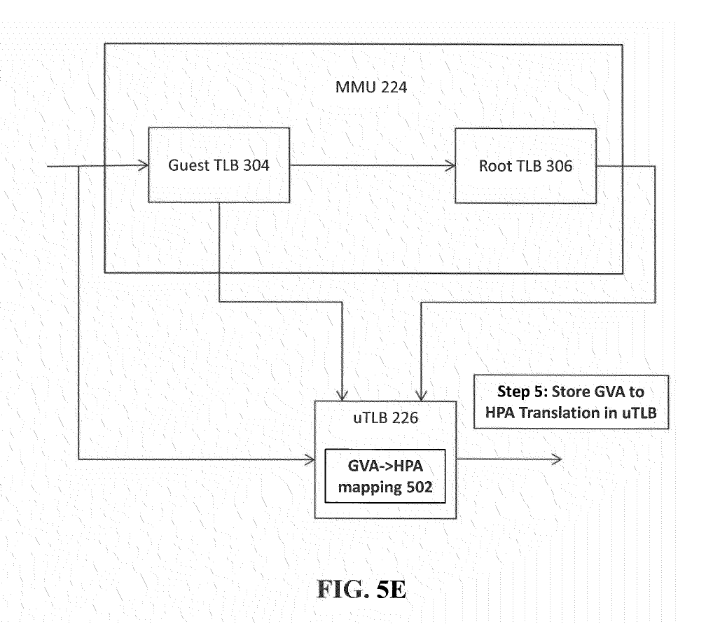

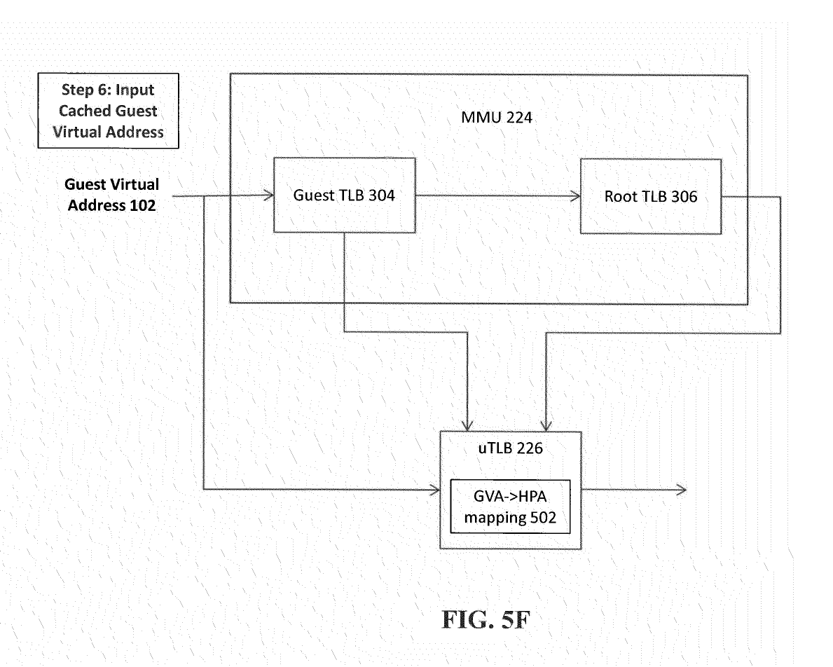

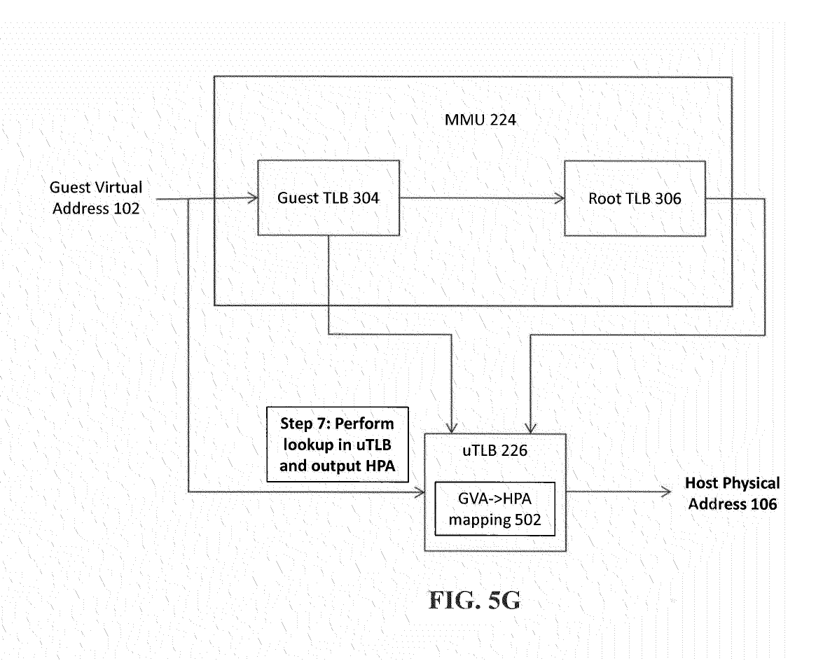

FIGS. 5A-G provide an illustrative example of this process. As shown in FIG. 5A, the first step involves receipt of a guest virtual address 102 by the memory management mechanism of the host processor. FIG. 5B illustrates the action of performing a lookup within the L1 cache (uTLB 226) to determine whether the uTLB includes a valid mapping for the guest virtual address 102.

Assume that uTLB 226 either does not contain an address mapping for the guest virtual address 102, or does contain an address mapping which is no longer valid. In this case, the procedure is to check for the required mappings within the L2 cache in the MMU 224. In particular, as shown in FIG. 5C, a lookup is performed against the guest TLB 304 to perform a translation of the guest virtual address 102 to obtain the guest physical address. Next, as shown in FIG. 5D, a lookup is performed against the root TLB 306 to perform a translation of the guest physical address 104 to obtain the host physical address 106.

FIG. 5E illustrates the action of storing these address translations from the L2 cache (guest TLB 304 and root TLB 306) to an entry 502 within the L1 cache (uTLB 226). This allows future translations for the same guest virtual address 102 to occur with a single lookup of the uTLB 226.

This is illustrated starting with FIG. 5F, where a subsequent memory access operation has caused that same guest virtual address 102 to be provided as input to the memory management mechanism. As shown in FIG. 5G, only a single lookup is needed at this point to perform the necessary address translations. In particularly, a single lookup operation is performed against the uTLB 226 to identify entry 502 to perform the translation of the guest virtual address 102 into the host physical address 106.

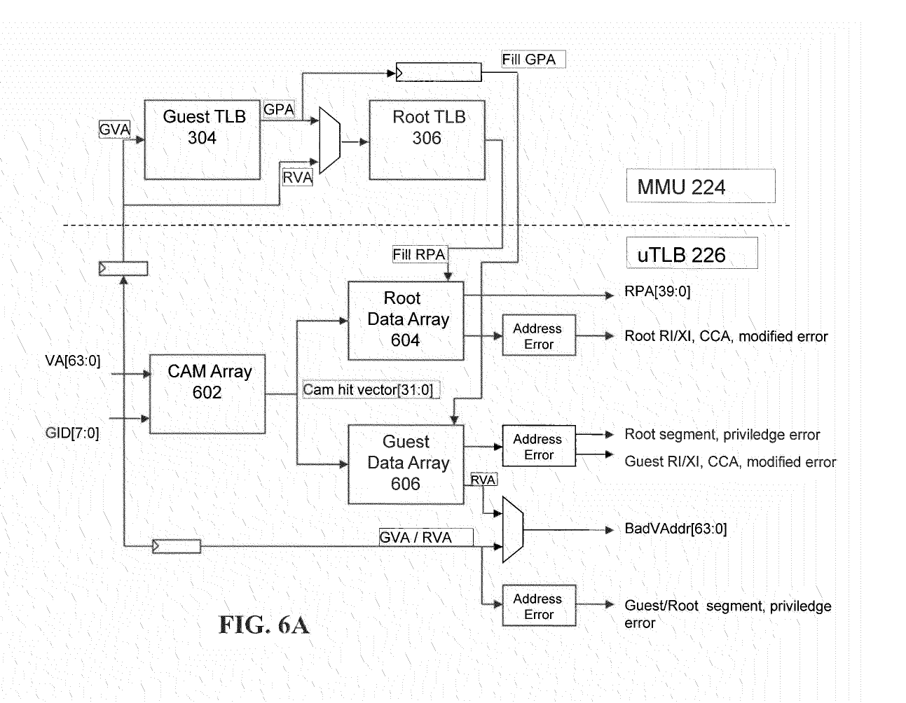

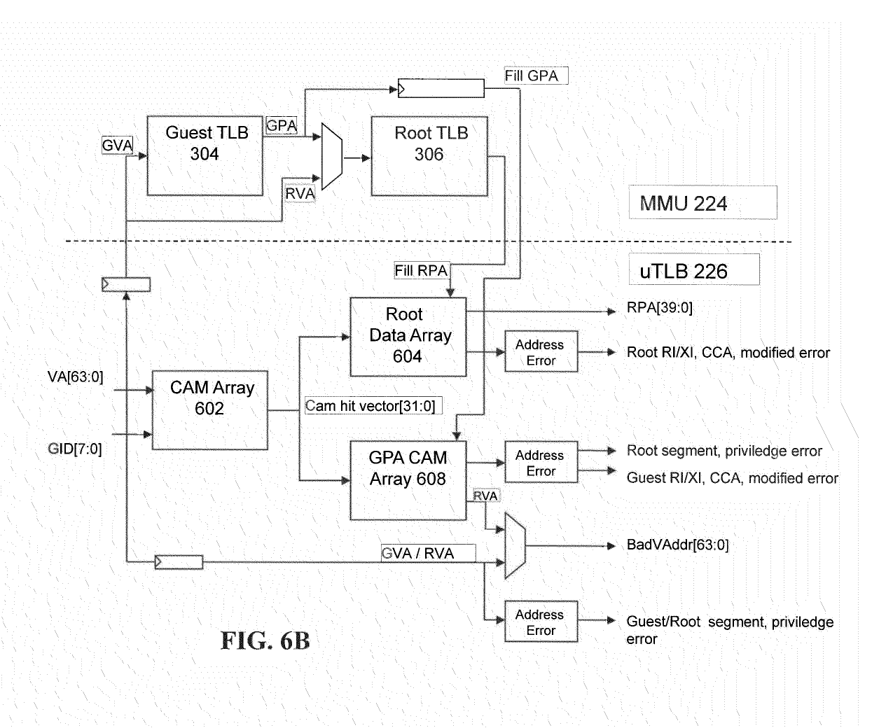

The uTLB 226 may be implemented using any suitable TLB architecture. FIG. 6A provides an illustration of one example approach that can be taken to implement the uTLB 226. In this example, the uTLB 226 includes a fully associative content addressable memory (CAM) 602. A CAM is a type of storage device which includes comparison logic with each bit of storage. A data value may be broadcast to all words of storage in the CAM and then compared with the values there. Words matching a data value may be flagged in some way. Subsequent operations can then work on flagged words, e.g. read them out one at a time or write to certain bit positions in all of them. Fully associative structures can therefore store the data in any location within the CAM structure. This allows very high speed searching operations to be performed with a CAM, since the CAM can search its entire memory with a single operation.

The uTLB 226 of FIG. 6A will also include higher density memory structures, such as root data array 604 and guest data array 606 to hold the actual translation data for the address information, where the CAM 602 is used to store pointers into the higher density memory devices 604 and 606. These higher density memory structures may be implemented, for example, as set associative memory (SAM) structures, such as a random access memory (RAM) structure. SAM structures organize caches so that each block of memory maps to a small number of sets or indexes. Each set may then include a number of ways. A data value may return an index whereupon comparison circuitry determines whether a match exists over the number of ways. As such, only a fraction of comparison circuitry is required to search the structure. Thus, SAM structures provide higher densities of memory per unit area as compared with CAM structures.

The CAM 602 stores mappings between address inputs and entries within the root data array 604 and the guest data array 606. The root data array 604 stores mappings to host physical addresses. The guest data array 606 stores mappings to guest physical addresses. In operation, The CAM 602 receives inputs in the form of addresses. In a virtualization context, the CAM 602 may receive a guest virtual address as an input. The CAM 602 provides a pointer output that identifies the entries within the root data array 604 and the guest data array 606 for a guest virtual address of interest.

In accordance with a further embodiment, FIG. 6B provides a different non-limiting example approach that can be taken to implement the uTLB 226. In FIG. 6B, guest data array 606 of FIG. 6A is replaced with a GPA CAM Array 608. The use of a GPA CAM Array 608 provides improved performance in order to invalidate cached mapping data. Specifically, in accordance with an embodiment of the present invention, a uTLB entry is created by combining a guest TLB 304 entry, which provides GVA to GPA translation, and the root TLB 306 entry which provides GPA to RPA translation, into a single GVA to RPA translation.

The uTLB 226 is a subset of MMU 306, in accordance with a further embodiment of the present invention. Therefore, a valid entry in the uTLB 226 must exist in MMU 306. Conversely, if an entry does not exist in MMU 224, then it cannot exist in the uTLB 226. As a result, if either half of the translation is removed from the MMU 224, then the full translation in the uTLB 226 also needs to be removed. If the GVA to GPA translation is removed from guest TLB 304, then the MMU instructs the uTLB 226 to CAM on the GVA in the CAM array 602. If a match is found, then the matching entry is invalidated, in accordance with an embodiment of the present invention. Likewise, if the GPA to RPA translation is removed from the root TLB 306, then the MMU instructs the uTLB 226 to CAM on the GPA in the GPA CAM Array 608.

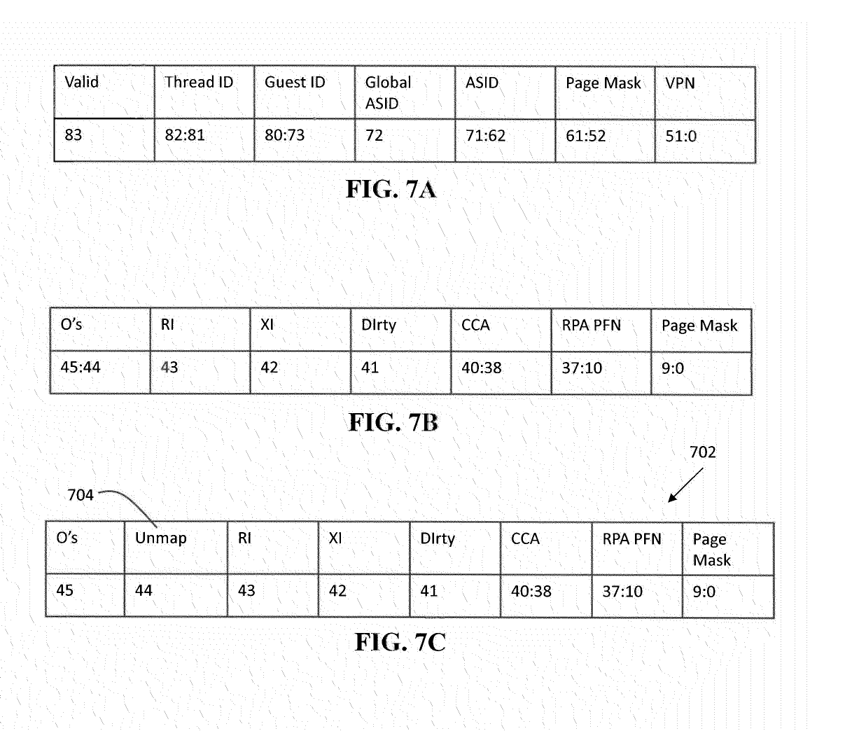

Moreover, since uTLB 226 includes both Root (RVA to RPA) and Guest (GVA to RPA) translations, additional information is included in the uTLB to disambiguate between the two contexts, in accordance with an embodiment of the present invention. This information includes, by way of non-limiting example, the Guest-ID field shown in FIG. 7A. This field may be 1 or more bits wide and may represent a unique number to differentiate between multiple Guest contexts (or processes) and the Root context. In this way, the uTLB 226 will still be able to identify the correct translation even if a particular GVA aliases an RVA. The Root context maintains Guest-ID state when launching a Guest context in order to enable this disambiguation, ensuring that all memory accesses executed by the Guest uses the Guest-ID. The Root also reserves itself a Guest-ID which is never used in a Guest context.

One skilled in the relevant arts will appreciate that while the techniques described herein can be utilized to improve the performance of GVA to RPA translations, they remain capable of handling RVA to RPA translations as well. In accordance with an embodiment of the present invention, the structure provided to improve the performance of GVA to RPA translations is usable to perform RVA to RPA translations without further modification.

FIGS. 7A-C provide examples of data array formats that may be used to implement the CAM array 602, root data array 604, and the guest data array 606. FIG. 7A shows examples of data fields that may be used to implement a CAM data array 602. FIG. 7B shows examples of data fields that may be used to implement a root data array 604. FIG. 7C shows examples of data fields that may be used to implement a guest data array 606.

Of particular interest is the “Unmap” data field 704 in the guest data array structure 702 of FIG. 7C. The Unmap data field 704 is used to check for the validity of mapped entries in the guest data array 606 in the event of a change of mapping status for a given memory region.

To explain, consider a system implementation that permits a memory region to be designated as definitively being “mapped”, “unmapped”, or either “mapped/unmapped”, A region that is definitively mapped corresponds to virtual addresses that require translation to a physical address. A region that is definitively unmapped corresponds to addresses that will bypass the translation since the address input is the actual physical address. A region that can be either mapped or unmapped creates the possibility of a dynamic change in the status of that memory region to change from being mapped to unmapped, or vice versa.

This means that a guest virtual address corresponds to a first physical address in a mapped mode, but that same guest virtual address may correspond to an entirely different second physical address in an unmapped mode. Since the memory may dynamically change from being mapped to unmapped, and vice versa, cached mappings may become incorrect after a dynamic change in the mapped/unmapped status of a memory region. In a system that supports these types of memory regions, the memory management mechanism for the host processor should be robust enough to be able to handle such dynamic changes in the mapped/unmapped status of memory regions.

If the memory management mechanism only supports a single level of caching, then this scenario does not present a problem since a mapped mode will result in a lookup of the requisite TLB while the unmapped mode will merely cause a bypass of the TLB. However, when multiple levels of caching are provided, then additional actions are needed to address the possibility of a dynamic change in the mapped/unmapped status of a memory region.

In some embodiments, a data field in the guest data array 606 is configured to change if there is a change in the mapped/unmapped status of the corresponding memory region. For example, if the array structure 702 of FIG. 7C is being used to implement the guest data array 606, then the bit in the “Unmap” data field 704 is set to indicate whether a mapping status change has occurred for a given memory region.

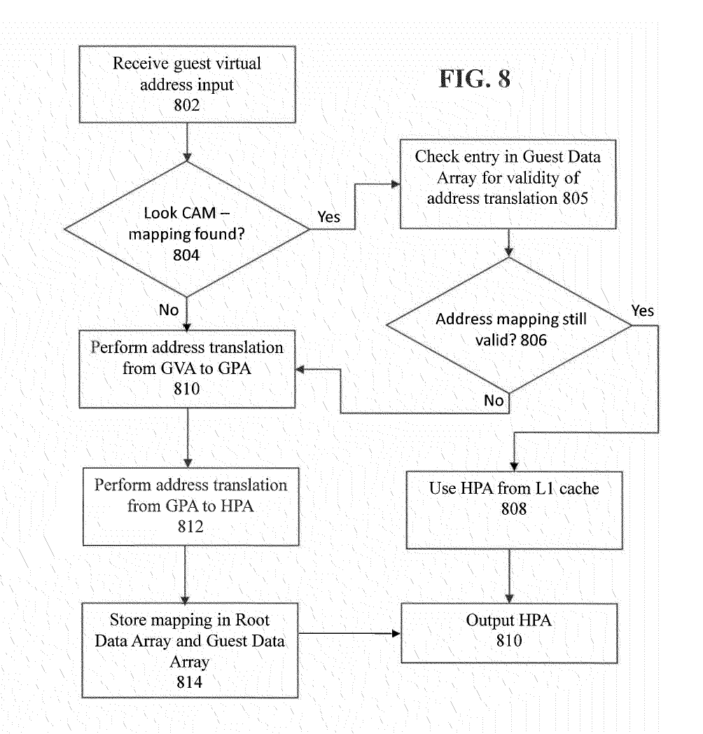

FIG. 8 shows a flowchart of an approach to implement memory accesses using the structure of FIGS. 6A-B in consideration of the possibility of a dynamic change in the mapped/unmapped status of a memory region. At 802, the guest virtual address is received for translation. This occurs, for example, when software on a virtual machine needs to perform some type of memory access operation. For example, an operating system on a virtual machine may have a need to access a memory location that is associated with a guest virtual address.

At 804, the CAM 602 is checked to determine whether a mapping exists for the guest virtual address within the L1 (uTLB) cache. If the CAM does not include an entry for the guest virtual address, then this means that the L1 cache does not include a mapping for that address. Therefore, the L2 cache is checked for the appropriate address translations. At 810, a lookup is performed within a guest TLB to perform a translation from the guest virtual address to a guest physical address. If the desired mapping data is not found in the guest TLB, then a page walker (e.g., a hardware page walker) is employed to perform the translation and to then store the mapping data in the guest TLB.

Once the guest physical address is identified, another lookup is performed at 812 within a root TLB to perform a translation from the guest physical address to a host physical address. If the desired mapping data is not found in the root TLB, then a page walker is employed to perform the translation between the GPA and the HPA, and to then store the mapping data in the root TLB.

At 814, the mapping data from the L2 cache (guest TLB and root TLB) is stored into the L1 cache (uTLB). This is to store the mapping data within the L1 cache so that the next time software on the virtual machine needs to access memory at the same guest virtual address, only a single lookup is needed (within the uTLB) to perform the necessary address translation or the memory access. In particular, mapping data from the root TLB is stored into the root data array 604 and mapping data from the guest TLB is stored into the guest data array 606.

One important item of information that is stored is the current mapped/unmapped status of the memory region of interest. The Unmap bit 704 in the guest data array structure 702 is set to indicate whether the memory region is mapped or unmapped.

The next time that a memory access results in the same guest virtual address being received at 802, then the check at 804 will result in an indication that a mapping exists in the L1 cache for the guest virtual address. However, it is possible that the mapped/unmapped status of the memory region of interest may have changed since the mapping information was cached, e.g., from being mapped to unmapped or vice versa.

At 805, a checking operation is performed to determine whether the mapped/unmapped status of the memory region has changed. This operation can be performed by comparing the current status of the memory region against the status bit in data field 704 of the cached mapping data. If there is a determination at 806 that the mapped/unmapped status of memory region has not changed, then at 808, the mapping data in the L1 cache is accessed to provide the necessary address translation for the desired memory access. If, however, there is a determination at 806 that the mapped/unmapped status of the memory region has changed, then the procedure will invalidate the cached mapping data within the L1 cache and will access the L2 cache to perform the necessary translations to obtain the physical address.

Therefore, what has been described is an improved approach for implementing a memory management mechanism in a virtualization environment. Multiple levels of caches are provided to perform address translations, where at least one of the caches contains a mapping between a guest virtual address and a host physical address. This type of caching implementation serves to minimize the need to perform costly multi-stage translations in a virtualization environment.

The present disclosure also describes an approach to implement a lookup structure that includes a content addressable memory (CAM) which is associated with multiple memory components. The CAM provides one or more pointers into the plurality of downstream memory structures. In some embodiments, a TLB for caching address translation mappings is embodied as a combination of a CAM associated with parallel downstream memory structures, where a first memory structure corresponds to a host address mappings and the second memory structure corresponds to guest address mappings.

While this invention has been described in terms of several preferred embodiments, there are alterations, permutations, and equivalents, which fall within the scope of this invention. It should also be noted that there are many alternative ways of implementing the methods and apparatuses of the present invention. Although various examples are provided herein, it is intended that these examples be illustrative and not limiting with respect to the invention. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A system for performing memory management, comprising:
a first level cache, wherein the first level cache comprises a single lookup structure to translate between a guest virtual address and a host physical address, in which the guest virtual address corresponds to a guest virtual memory for software that operates within a virtual machine, the virtual machine corresponding to virtual physical memory is accessible using a guest physical address, and wherein the virtual machine corresponds to a host physical machine having host physical memory accessible by the host physical address; and
a second level cache, wherein the second level cache comprises a multiple lookup structure to translate between the guest virtual address and the host physical address.

2. The system of claim 1, in which the second level cache comprises a first translation lookaside buffer (TLB) and a second TLB.

3. The system of claim 2, in which the first TLB comprises a mapping entry to correlate the guest virtual address to a guest physical address.

4. The system of claim 2, in which the second TLB comprises a mapping entry to correlate a guest physical address to the host physical address.

5. The system of claim 2, in which operation of the system to perform an address translation using the second level corresponds to a first lookup operation for the first TLB and a second lookup operation for the second TLB.

6. The system of claim 1, in which the first level cache comprises a micro-TLB

7. The system of claim 1, in which the first level cache comprises a memory to hold mapping entries to translate the guest virtual address into the host physical address.

8. The system of claim 1, in which the first level cache comprises a content addressable memory (CAM) in communication with at least downstream two memory devices.

9. The system of claim 8, in which the CAM comprises pointers that point to entries within the at least two memory devices.

10. The system of claim 8, in which the at least two downstream memory devices comprises a first memory device to hold an address mapping for the host physical address and a second memory device to hold another address mapping for a guest physical address.

11. The system of claim 1, in which the first level cache comprises an invalidation mechanism to invalidate cached entries.

12. A method implemented with a processor for performing memory management, comprising:
accessing a first level cache to perform a single lookup operation to translate between a guest virtual address and a host physical address; and
accessing a second level cache if a cache miss occurs at the first level cache, wherein a first lookup operation is performed at the second level cache to translate between the guest virtual address and a guest physical address, and a second lookup operation is performed at the second level cache to translate between the guest physical address and the host physical address.

13. The method of claim 12, in which the first lookup operation performed at the second level cache to translate between the guest virtual address and the guest physical address is implemented by accessing a first translation lookaside buffer (TLB), and the second lookup operation performed at the second level cache to translate between the guest physical address and the host physical address is implemented by accessing a second TLB.

14. The method of claim 13, in which the first TLB comprises a mapping entry to correlate the guest virtual address to the guest physical address.

15. The method of claim 13, in which the second TLB comprises a mapping entry to correlate the guest physical address to the host physical address.

16. The method of claim 12, in which the first level cache comprises a micro-TLB (uTLB).

17. The method of claim 16, in which the uTLB comprises a memory to hold mapping entries to translate the guest virtual address into the host physical address.

18. The method of claim 12, in which the first level cache comprises a content addressable memory (CAM) in communication with at least downstream two memory devices.

19. The method of claim 18, in which the guest virtual address is used by the CAM to search for pointers that point to entries within the at least two memory devices, where the at least two downstream memory devices comprises a first memory device to hold an address mapping for the host physical address and a second memory device to hold another address mapping for a guest physical address.

20. The method of claim 19, in which the first memory device is accessed to obtain the host physical address and the second memory device is accessed to obtain the guest physical address.

21. The method of claim 19, in which a status of a memory region corresponding to the guest virtual address is checked to determine if a mapping status has changed for the memory region since translation data has last been cached for the memory region.

22. The method of claim 21, in which a data value indicating a mapped or unmapped status of the memory region is maintained in the second memory device, and the data value is checked to determine whether the mapping status has changed.

23. The method of claim 21, in which recognition of the status change causes invalidation of cached translation data.

24. A memory management structure, comprising:
a content addressable memory (CAM) comprising pointer entries to a first memory device and a second memory device;
the first memory device comprising a first set of stored content; and
the second memory device comprising a second set of stored content, wherein both the first memory device and the second memory device are parallel downstream devices referenceable by the CAM using a single input data value to access both the first set of stored. content and the second set of stored content,

25. The memory management structure of claim 24, in which the CAM comprises a fully associative CAM.

26. The memory management structure of claim 24, in which the first and second memory devices comprise set associative memory devices.

27. The memory management structure of claim 24, in which the first and second memory devices comprise random access memory (RAM) devices.

28. The memory management structure of claim 24, in which the CAM, the first memory device, and the second memory device are embodied in a memory management unit of a processor.

29. The memory management structure of claim 28, in which the memory management unit manages access to physical memory.

30. The memory management structure of claim 24, in which the first and second memory devices hold address translation data.

31. The memory management structure of claim 30, in which the memory management structure is configured to translate between a guest virtual address and a host physical address, in which the guest virtual address corresponds to a guest virtual memory for software that operates within a virtual machine, the virtual machine corresponding to virtual physical memory is accessible using a guest physical address, and wherein the virtual machine corresponds to a host physical machine having host physical memory accessible by the host physical address.

32. The memory management structure of claim 31, in which the first memory device holds address translation data to translate to the host physical address.

33. The memory management structure of claim 32, in which the second memory device holds address translation data to translate to the guest physical address.

34. The memory management structure of claim 33, in which the address translation data comprises information pertaining to a status of a memory region corresponding to the guest virtual address.

35. The memory management structure of claim 34, in which the information comprises a status field that is configured to indicate whether the memory region is mapped or unmapped.

36. The memory management structure of claim 24, embodied as a data cache for address translations.

37. The memory management structure of claim 24, further comprising:
a Guest Physical Address (GPA) CAM array, wherein the memory management structure is configured to instruct the GPA CAM array to invalidate matching entries in a micro-TLB (uTLB) based on removal of a GPA to Root Physical Array (RPA) translation from a root TLB.

38. The memory management structure of claim 24, wherein a micro-TLB (uTLB) is configured to include information to disambiguate between root and guest translation contexts.

39. The memory management structure of claim 30, wherein the memory management structure is configured to translate between a host virtual address and a host physical address

40. A method, comprising:
providing a single input to a content addressable memory (CAM); and
searching the CAM using the single input to identify pointers to entries to a first memory device and a second memory device, wherein both the first memory device and the second memory device are parallel downstream devices that are referenceable by the CAM using the single input to access both a first set of stored content in the first memory device and a second set of stored content in the second memory device.

41. The method of claim 40, in which the CAM comprises a fully associative CAM.

42. The method of claim 40, in which the first and second memory devices comprise set associative memory devices.

43. The method of claim 40, in which the first and second memory devices comprise random access memory (RAM) devices.

44. The method of claim 40, in which the CAM, the first memory device, and the second memory device are accessed to operate a memory management unit of a processor.

45. The method of claim 44, in which the memory management unit is operated to manage access to physical memory.

46. The method of claim 40, in which the content in the first and second memory devices comprise address translation data.

47. The method of claim 46, in which translation performed between a guest virtual address and a host physical address using the address translation data, in which the guest virtual address corresponds to a guest virtual memory for software that operates within a virtual machine, the virtual machine corresponding to virtual physical memory is accessible using a guest physical address, and wherein the virtual machine corresponds to a host physical machine having host physical memory accessible by the host physical address.

48. The method of claim 47, in which the first memory device holds address translation data to translate to the host physical address.

49. The method of claim 47, in which the second memory device holds address translation data to translate to the guest physical address.

50. The method of claim 47, in which a status of a memory region corresponding to the guest virtual address is checked to determine if a mapping status has changed for the memory region since translation data has last been cached for the memory region.

51. The method of claim 50, in which a data value indicating a mapped or unmapped status of the memory region is maintained in the second memory device, and the data value is checked to determine whether the mapping status has changed.

52. The method of claim 50, in which recognition of the status change causes invalidation of cached translation data.
